(19) United States
(12) Patent Application Publication
(10) Pub. No.: US 2005/0135265 A1
(43) Pub. Date: Jun. 23, 2005

(54) Method and system for enabling applications to optimize communications in a network environment

(76) Inventors: George P. Moakley, Phoenix, AZ (US); Steven L. Grobman, El Dorado Hills, CA (US)

Correspondence Address: BLAKELY SOKOLOFF TAYLOR & ZAFMAN, 12400 WILSHIRE BOULEVARD, SEVENTH FLOOR, LOS ANGELES, CA, 90025-1030, US

(21) Appl. No.: 10/746,897

(22) Filed: Dec. 23, 2003

(51) Int. Cl. H04L 12/26

(52) U.S. Cl. 370/252

(57) ABSTRACT

A method and system for enabling applications to optimize communications in a network environment is described. The method includes determining a set of application parameters for an application on a user device, determining one or more communications pathways coupled to the user device, determining a plurality of pathway parameters associated with each communications pathway, and selecting the communications pathway with pathway parameters that best match the application parameters of the application.

### BACKGROUND

1. Technical Field

Embodiments of the invention relate to the field of network communication applications, and more specifically to enabling applications to optimize communications in a network environment.

2. Background Information and Description of Related Art

In a wired environment, the number of network options available to an application matches the number of wired network connections attached to the computing platform. For personal computers (PCs), the number of network connections is usually one. However, a wirelessly enabled user device, such as a notebook PC, tablet PC, or PDA, may encounter multiple communication options as it moves through different environments, and each option may represent a different set of parameters, such as cost, bandwidth, latency, and security levels. Additionally, not all application services are available through all connections. Therefore, a wireless user may want to make use of various communication options available to the wireless user devices when the options become available.

### BRIEF DESCRIPTION OF DRAWINGS

The invention may best be understood by referring to the following description and accompanying drawings that are used to illustrate embodiments of the invention. In the drawings:

FIG. 1 is a block diagram illustrating one generalized embodiment of a system incorporating the invention.

FIG. 2 is an exemplary connection list of an optimizer utility according to an embodiment of the invention.

FIG. 3 is a flow diagram illustrating a method according to an embodiment of the invention.

FIG. 4 is a block diagram illustrating a suitable computing environment in which certain aspects of the illustrated invention may be practiced.

### DETAILED DESCRIPTION

Embodiments of a system and method for enabling applications to optimize communications in a network environment are described. In the following description, numerous specific details are set forth. However, it is understood that embodiments of the invention may be practiced without these specific details. In other instances, well-known circuits, structures and techniques have not been shown in detail in order not to obscure the understanding of this description.

Reference throughout this specification to “one embodiment” or “an embodiment” means that a particular feature, structure, or characteristic described in connection with the embodiment is included in at least one embodiment of the invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

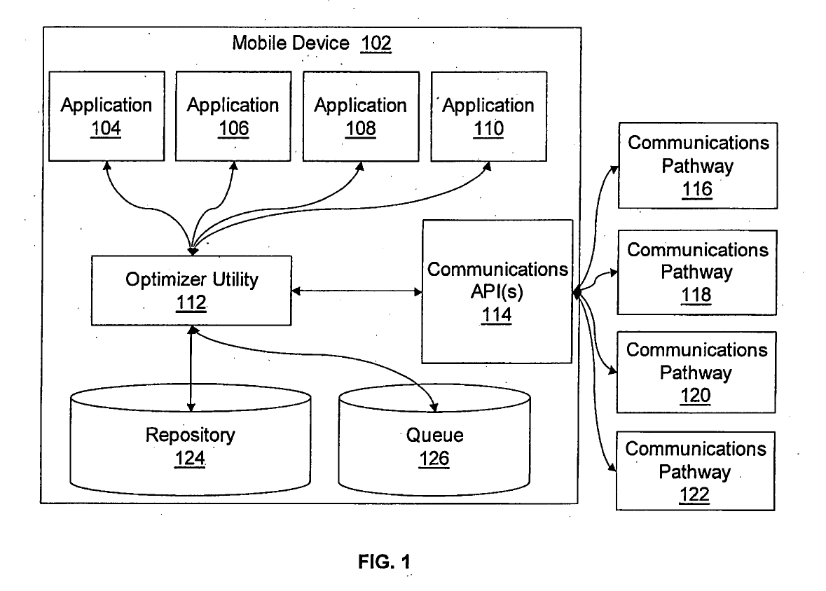

Referring to FIG. 1, a block diagram illustrates a device 100 according to one embodiment of the invention. Those of ordinary skill in the art will appreciate that the device 100 may include more components than those shown in FIG. 1. However, it is not necessary that all of these generally conventional components be shown in order to disclose an illustrative embodiment for practicing the invention.

The device 102 may be a mobile device, such as a notebook personal computer (PC), tablet PC, handheld computer, or personal digital assistant (PDA). The device 102 has one or more applications, such as 104, 106, 108, or 110. These applications may require communications via a communications pathway, such as 116, 118, 120, or 122, to interact with peer applications or server based applications. The communications pathways may be implemented through the use of a host-only network, where the actual connectivity is routed through the actual networks. This provides a consistent network environment for applications even if the communications pathways change to allow optimal connectivity.

An optimizer utility 112 develops a profile for each of these applications and communications pathways and stores these profiles in a repository 124. These profiles may be derived from information pre-loaded into the optimizer utility, information provided to the optimizer by the applications and/or pathways, or history information gathered and complied by the optimizer as applications and pathways are used. The information in the profiles may include parameters such as cost, latency, bandwidth, level of security, or historical performance. As each application attempts to connect with a communications pathway through a communications application program interface (API), which insulates the application from the details of the communications pathway, the optimizer utility 112 determines which available communications pathway best suits the communications parameters of the application. The best suited communications pathway is then selected by the optimizer utility for the application.

The optimizer utility 112 tracks sessions between applications and applicable peers and/or services. This enables the optimizer to re-route a session between an application and application peers/services in the event that a communications pathway is lost or a new pathway is encountered or regained that is better suited for the session (e.g. less expensive or lower latency). The optimizer utility 112 may also queue communications to/from applications and their applicable peers/services in the event that an application is temporarily off-line, or no suitable communications pathway is available (e.g. too expensive or inadequately secure). State information about the session may be maintained in the repository 124 to facilitate recovery should the optimizer utility need to be restarted.

The optimizer utility 112 has several components and functions. The optimizer utility 112 manages application communications and characterizes each application according to its communications needs. A profile is developed for each application that includes information about the application's communications needs. The optimizer utility 112 monitors communications hardware, such as wireless network interface cards (NICs), to detect appearance, disappearance, and relative quality of each communications pathway as they are encountered and lost. A list of each communications pathway and it associated parameters, such as cost, bandwidth, latency, and security options, is maintained. The applications profiles and communications pathway profiles may be stored in the repository 124. When an application attempts to connect with a communications pathway, the optimizer utility 112 compares the application's communications requirements with the parameters of the communications pathways to determine which communications pathway is best suited to be used for the given communication. If no suitable communications pathway is available, the optimizer utility 112 queues that application's communications until a suitable communications pathway becomes available.

In one embodiment, the optimizer utility provides meta-data about the current state of a communications pathway to applications such that optimal decisions may be made. The content of the meta-data may include cost, latency, bandwidth, level of security, or historical performance. An application may decide to take an action or not take an action based on the meta-data. For example, an email application may detect that it is on a high cost network and choose not to download a 50 MB address book.

In one embodiment, the networks may self describe aspects of the meta-data to influence connection decisions. In one embodiment, the network metadata is encoded in Dynamic Host Control Protocol (DHCP) or a pointer supplied by DHCP. Examples of the content of the meta-data include but are not limited to cost, bandwidth, or level of security.

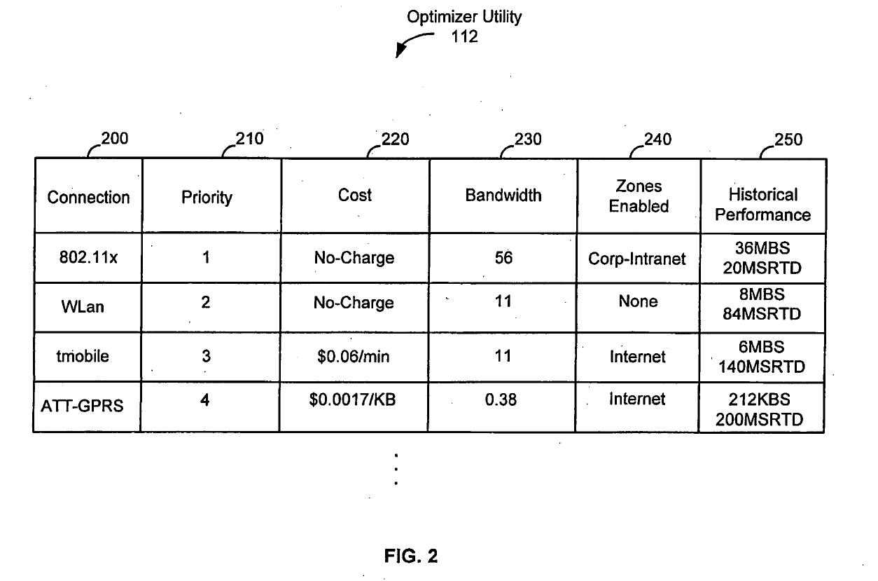

FIG. 2 is an exemplary connection list of an optimizer utility according to an embodiment of the invention. In the example shown, there are four available connections: 802.11x, WLan, tmobile, and ATT-GPRS. Each connection has several associated parameters, such as cost, bandwidth, enabled zones, and historical performance. The priority of each connection may be determined based on one or more of the other parameters, such as cost, bandwidth, or historical performance. The connections may be automatically configured or configured via user intervention. The optimizer utility 112 selects one of the connections for an application's communication based on each connection's parameters and the communication requirements of the application. The best suited connection is selected for each application communication.

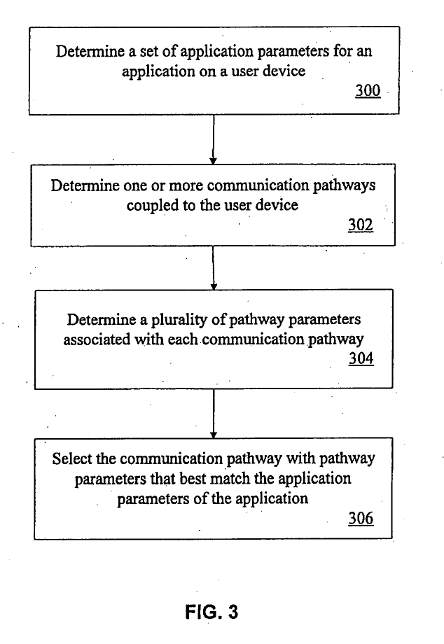

FIG. 3 illustrates a method according to one embodiment of the invention. At 300, a set of application parameters for an application on a user device is determined. At 302, one or more communications pathways coupled to the user device are determined. At 304, a plurality of pathway parameters associated with each communications pathway is determined. The pathway parameters may include a cost parameter, a latency parameter, a bandwidth parameter, a historical performance parameter, and/or a security parameter. In one embodiment, the parameters of the communications pathways are automatically configured. In one embodiment, one or more parameters of one or more communications pathways are configured via user intervention. At 306, the communications pathway with pathway parameters that best match the application parameters of the application is selected. In one embodiment, the pathway parameters are prioritized. Then, the communications pathway is selected based on the priorities of the pathway parameters.

In one embodiment, meta-data about a communications pathway is provided to the application. One or more actions may be taken or not taken by the application based on the meta-data. For example, an application may decide to not take an action based on the cost of the network. In one embodiment, networks may self-describe aspects of the meta-data to influence connection decisions. Examples of the content of the meta-data include but are not limited to cost, bandwidth, or level of security. In one embodiment, the network meta-data may be encoded in DHCP or a pointer supplied by DHCP.

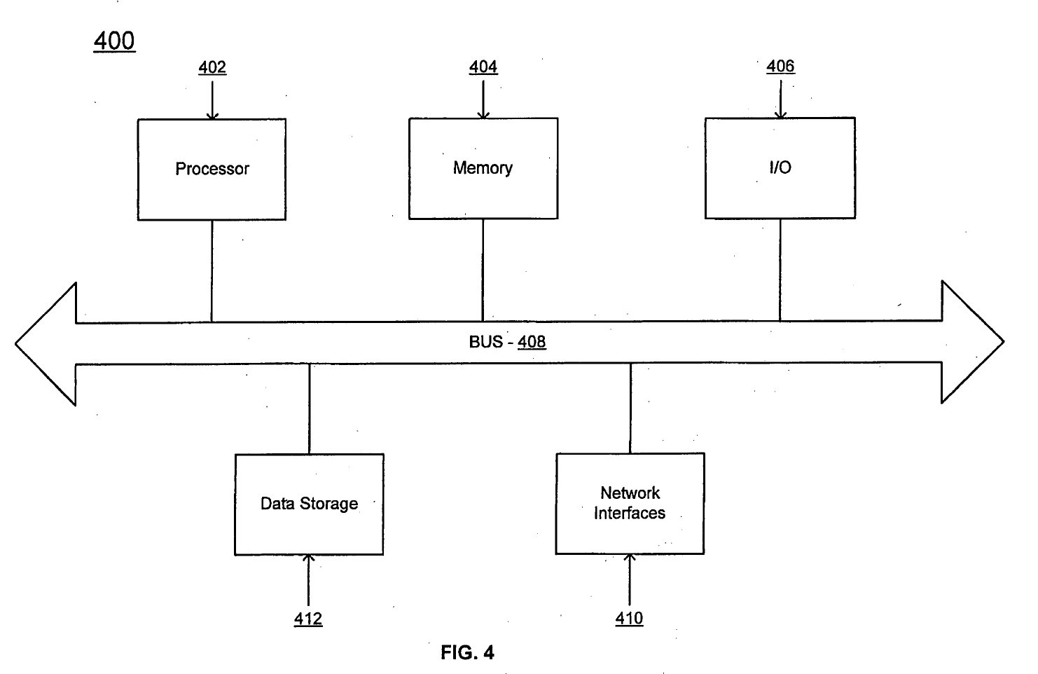

FIG. 4 is a block diagram illustrating a suitable computing environment in which certain aspects of the illustrated invention may be practiced. In one embodiment, the method described above may be implemented on a computer system 400 having components 402-412, including a processor 402, a memory 404, an Input/Output device 406, a data storage device 412, and a network interface 410, coupled to each other via a bus 408. The components perform their conventional functions known in the art and provide the means for implementing the device 100. Collectively, these components represent a broad category of hardware systems, including but not limited to general purpose computer systems and specialized packet forwarding devices. It is to be appreciated that various components of computer system 400 may be rearranged, and that certain implementations of the present invention may not require nor include all of the above components. Furthermore, additional components may be included in system 400, such as additional processors (e.g., a digital signal processor), storage devices, memories, and network or communication interfaces.

As will be appreciated by those skilled in the art, the content for implementing an embodiment of the method of the invention, for example, computer program instructions, may be provided by any machine-readable media which can store data that is accessible by device 100, as part of or in addition to memory, including but not limited to cartridges, magnetic cassettes, flash memory cards, digital video disks, random access memories (RAMs), read-only memories (ROMs), and the like. In this regard, the device 100 is equipped to communicate with such machine-readable media in a manner well-known in the art.

It will be further appreciated by those skilled in the art that the content for implementing an embodiment of the method of the invention may be provided to the device 100 from any external device capable of storing the content and communicating the content to the device 100. For example, in one embodiment of the invention, the device 100 may be connected to a network, and the content may be stored on any device in the network.

While the invention has been described in terms of several embodiments, those of ordinary skill in the art will recognize that the invention is not limited to the embodiments described, but can be practiced with modification and alteration within the spirit and scope of the appended claims. The description is thus to be regarded as illustrative instead of limiting.

1. A method comprising:
determining a set of application parameters for an application on a user device;
determining one or more communications pathways coupled to the user device;
determining a plurality of pathway parameters associated with each communications pathway; and
selecting the communications pathway with pathway parameters that best match the application parameters of the application.

2. The method of claim 1, further comprising prioritizing the pathway parameters.

3. The method of claim 2, wherein selecting the communications pathway comprises selecting the communications pathway based on the priorities of the pathway parameters.

4. The method of claim 1, wherein determining a plurality of pathway parameters associated with each communications pathway comprises configuring via user intervention one or more pathway parameters associated with one or more of the communications pathways.

5. The method of claim 1, wherein the pathway parameters include a cost parameter.

6. The method of claim 1, wherein the pathway parameters include a security parameter.

7. The method of claim 1, wherein the pathway parameters include a latency parameter.

8. The method of claim 1, wherein the pathway parameters include a bandwidth parameter.

9. The method of claim 1, wherein the pathway parameters include a historical performance parameter.

10. The method of claim 1, further comprising providing meta-data about a communications pathway to the application.

11. The method of claim 10, wherein the meta-data comprises cost.

12. The method of claim 11, further comprising deciding not to take an action based on the cost.

13. The method of claim 1, wherein meta-data is self-described by a network to influence connection decisions.

14. The method of claim 13, wherein the meta-data comprises cost.

15. The method of claim 13, wherein the meta-data comprises bandwidth.

16. The method of claim 13, wherein the meta-data is encoded in Dynamic Host Control Protocol (DHCP).

17. The method of claim 1, wherein the communications pathways are implemented through use of a host-only network.

18. An article of manufacture comprising:
a machine accessible medium including content that when accessed by a machine causes the machine to perform operations comprising:
determining a set of application parameters for an application on a user device;
determining one or more communications pathways coupled to the user device;
determining a plurality of pathway parameters associated with each communications pathway; and
selecting the communications pathway with pathway parameters that best match the application parameters of the application.

19. The article of manufacture of claim 18, wherein the machine-accessible medium further includes content that causes the machine to perform operations comprising prioritizing the pathway parameters.

20. The article of manufacture of claim 19, wherein the machine accessible medium including content that when accessed by the machine causes the machine to perform operations comprising selecting the communications pathway comprises the machine accessible medium including content that when accessed by the machine causes the machine to perform operations comprising selecting the communications pathway based on the priorities of the pathway parameters.

21. The article of manufacture of claim 18, wherein the machine accessible medium including content that when accessed by the machine causes the machine to perform operations comprising determining a plurality of pathway parameters associated with each communications pathway comprises the machine accessible medium including content that when accessed by the machine causes the machine to perform operations comprising automatically configuring a plurality of pathway parameters associated with each communications pathway.

22. The article of manufacture of claim 18, wherein the machine accessible medium including content that when accessed by the machine causes the machine to perform operations comprising determining a plurality of pathway parameters associated with each communications pathway comprises the machine accessible medium including content that when accessed by the machine causes the machine to perform operations comprising determining a cost parameter associated with each communications pathway.

23. The article of manufacture of claim 18, wherein the machine accessible medium including content that when accessed by the machine causes the machine to perform operations comprising determining a plurality of pathway parameters associated with each communications pathway comprises the machine accessible medium including content that when accessed by the machine causes the machine to perform operations comprising determining a security parameter associated with each communications pathway.

24. The article of manufacture of claim 18, wherein the machine accessible medium including content that when accessed by the machine causes the machine to perform operations comprising determining a plurality of pathway parameters associated with each communications pathway comprises the machine accessible medium including content that when accessed by the machine causes the machine to perform operations comprising determining a latency parameter associated with each communications pathway.

25. The article of manufacture of claim 18, wherein the machine accessible medium including content that when accessed by the machine causes the machine to perform operations comprising determining a plurality of pathway parameters associated with each communications pathway comprises the machine accessible medium including content that when accessed by the machine causes the machine to perform operations comprising determining a bandwidth parameter associated with each communications pathway.

26. The article of manufacture of claim 18, wherein the machine accessible medium including content that when accessed by the machine causes the machine to perform operations comprising determining a plurality of pathway parameters associated with each communications pathway comprises the machine accessible medium including content that when accessed by the machine causes the machine to perform operations comprising determining a historical performance parameter associated with each communications pathway.

27. A system comprising:
a processor;
a network interface coupled to the processor; and
a machine accessible medium including data that when accessed by the processor causes the processor to perform operations comprising:
determining a set of application parameters for an application on a user device;
determining one or more communications pathways coupled to the user device;
determining a plurality of pathway parameters associated with each communications pathway; and
selecting the communications pathway with pathway parameters that best match the application parameters of the application

28. The system of claim 27, wherein the machine-accessible medium further includes content that causes the machine to perform operations comprising prioritizing the pathway parameters.

29. The system of claim 27, wherein the machine accessible medium including content that when accessed by the machine causes the machine to perform operations comprising determining a plurality of pathway parameters associated with each communications pathway comprises the machine accessible medium including content that when accessed by the machine causes the machine to perform operations comprising automatically configuring a plurality of pathway parameters associated with each communications pathway.
